(19) United States
(12) Patent Application Publication
(10) Pub. No.: US 2016/0323489 A1
(43) Pub. Date: Nov. 3, 2016

(54) SMART LIGHTING DEVICE AND RELATED CAMERA SYSTEM THEREOF

(71) Applicant: SENGLED OPTOELECTRONICS CO., LTD., Tongxiang, Zhijiang (CN)

(72) Inventors: SHUMIN TANG, Tongxiang (CN); ZHONGDING WANG, Tongxiang (CN); JINXIANG SHEN, Tongxiang (CN)

(21) Appl. No.: 15/026,353

(22) PCT Filed: May 8, 2015
(86) PCT No.: PCT/CN2015/078596

§ 371 Date: Mar. 31, 2016

(30) Foreign Application Priority Data
Oct. 23, 2014 (CN) 201410570707.6

(51) Int. Cl. H04N 5/225; H04N 5/235; F21V 23/04; H04R 1/02; H04R 27/00; F21V 33/00; H04N 5/232; H04N 7/18

(52) U.S. Cl. CPC H04N 5/2257; H04N 5/2252; H04N 5/2253; H04N 5/2254; H04N 5/2256; H04N 5/23216; H04N 5/23212; H04N 5/23219; H04N 5/2354; H04N 7/181; H04R 1/028; H04R 27/00; F21V 33/0052; F21V 33/0056; F21V 23/0464; H04R 2227/001; F21Y 2115/10

(57) ABSTRACT

The present disclosure provides a smart lighting device, including a lamp cap, a housing, a circuit board. The smart light further includes a light-emitting module, a supplemental lighting module, a camera module and a sensor module that are mounted inside the housing and electrically connected to the circuit board. The lamp cap and the housing are connected. The camera module, the supplemental lighting module and the sensor module are located around the light-emitting module. The present disclosure also provides a camera system including one or more disclosed smart lights and one or more routers. Each smart lighting device is connected to a router on a local network. The routers are connected to the Internet. Further, the smart lighting devices are configured to record camera data records, and send the camera data records to the Internet through the routers in real-time or upload the camera data records to a cloud storage.

### CROSS-REFERENCES TO RELATED APPLICATIONS

This application is a national stage application under 35 USC §371(c) of PCT Application No. PCT/CN2015/078596, entitled “Smart Lighting Device And Related Camera System Thereof” filed on May 8, 2015, which claims the priority of Chinese Patent Application No. 201410570707.6, filed on Oct. 23, 2014. The entire disclosure and contents of the above applications are hereby incorporated by reference herein.

### FIELD OF THE DISCLOSURE

The present disclosure generally relates to the field of lighting technologies and, more particularly, relates to a smart lighting device with an integrated camera system.

### BACKGROUND

Lighting devices often use various light sources to illuminate comfortable and pleasant environments to provide good visibility for working and living activities. Nowadays, lighting devices have become more and more intelligent. In a smart home, lighting devices may be connected to the home network by network technologies, enabling lighting control through the network. Therefore, lighting devices have become a part of smart devices in a smart home environment to bring unique smart experience to users and to create a comfortable living environment.

Along with the development of smart technologies, there is higher demand for increased intelligence of smart terminal devices in a smart home environment. How to integrate resources, enhance applications of smart lights, and make home smart device simple and well integrated has recently become the development focus of smart technologies.

Home security is an important aspect in smart home applications. Combining with applications of smart lights, existing technical strategies often add a camera to a smart light to capture videos or images. One approach is to connect a camera component next to an existing lighting fixture, which introduces complicated electrical and mechanical structures. Another approach is to set up a camera in the middle of a light-emitting module of a lighting fixture. However, this approach may impair the illumination range of the lighting fixture and cause dark areas, which may affect the lighting effect and image/video recording results.

To promote intelligent applications of smart lights, it is desirable to provide a smart lighting device having camera functions besides normal lighting capabilities and/or a camera system using the smart light. The smart lighting device may have simple structures and fit into a smart home environment. The disclosed method and system for a smarting lighting device with an integrated camera are directed to solve one or more problems set forth above and other problems in the art.

### BRIEF SUMMARY OF THE DISCLOSURE

One aspect of the present disclosure provides a smart lighting device, including a lamp cap, a housing, a circuit board, a light-emitting module, a supplemental lighting module, a camera module and a sensor module. The lamp cap is configured to connect the smart lighting module with a power source. The camera module is configured to capture videos or images in a surrounding area of the smart light. The supplemental lighting module is configured to provide supplemental light to the camera module. The circuit board is configured to control the light-emitting module, the supplemental lighting module, the camera module, and the sensor module. Further, the light-emitting module, the supplemental lighting module, the camera module, and the sensor module are mounted inside the housing and electrically connected to the circuit board. The circuit board is mounted inside the housing and electrically connected to the lamp cap. The lamp cap and the housing are connected. In addition, the camera module, the supplemental lighting module and the sensor module are located around the light-emitting module.

Another aspect of the present disclosure provides a camera system including one or more routers and one or more smart lighting devices. Each of the smart lighting devices may be configured to include a lamp cap, a housing, a circuit board, a light-emitting module, a supplemental lighting module, a camera module and a sensor module. Each smart lighting device is connected to a router in a local network. The routers may connect to the Internet. The smart lighting device may record camera data records using the camera module, and send the camera data records to the Internet through the routers in real-time or upload the camera records to a cloud storage.

Another aspect of the present disclosure provides a camera system including a smart terminal, one or more routers and one or more smart lighting devices. Each of the smart lighting devices may be configured to include a lamp cap, a housing, a circuit board, a light-emitting module, a supplemental lighting module, a camera module and a sensor module. Each smart lighting device is connected to a router in a local network. The routers may connect to the Internet. The smart lighting device may record camera records using the camera module, and send the camera records to the Internet through the routers in real-time or upload the camera records to a cloud storage. Further, the smart terminal is configured to access the camera data records in real-time through the Internet or access the uploaded camera data records in the cloud storage.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a partial perspective structure diagram illustrating an exemplary smart lighting device consistent with various embodiments of the present disclosure;

FIG. 2 is a structure diagram illustrating an exemplary circuit board of an exemplary smart lighting device consistent with various embodiments of the present disclosure; and

FIG. 3 is a structure diagram illustrating an exemplary camera system consistent with various embodiments of the present disclosure

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

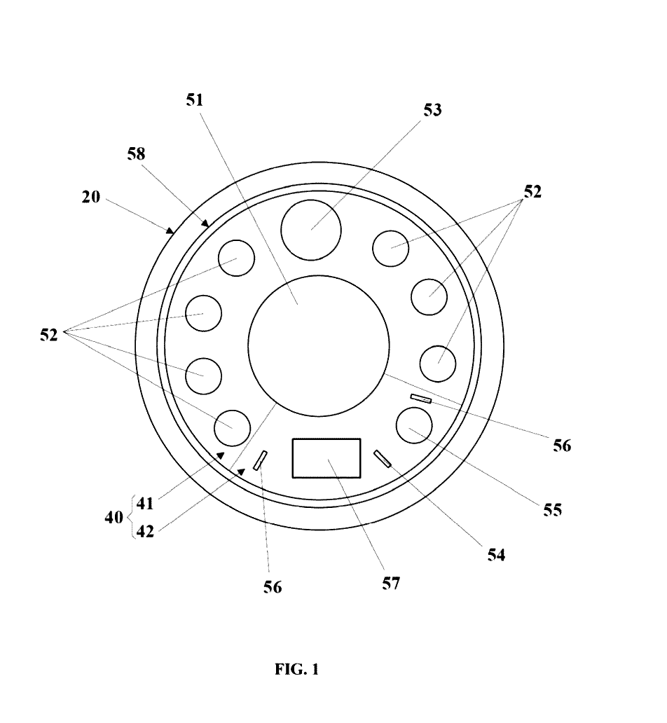

FIG. 1 is a partial perspective structure diagram illustrating an exemplary smart lighting device consistent with the present disclosure. As shown in FIG. 1, the exemplary smart lighting device may have a light module for providing lighting for a designated workspace or living space. The light module may be one or more smart LED (Light Emitting Diode) light modules, each including a lamp cap (not shown), a housing 20, a circuit board (not shown) and a light-emitting module 51. The light-emitting module 51 may be an LED light-emitting module or a traditional light-emitting module. Further, the light-emitting module 51 may include a single lamp bead or a collection of multiple lamp beads. A lamp bead may include one LED light or multiple LED lights. The housing 20 of the smart LED light may provide a plastic base for assembling various components. The circuit board may be placed inside the housing 20 and electrically connected to the lamp cap. The circuit board may control various modules of the smart LED light to perform corresponding functions. The lamp cap may be connected (e.g., a permanent fixed connection or other connections) to the housing 20 for mounting the smart LED light and connecting the smart LED light with power source. The LED light-emitting module 51 may be placed inside the housing 20 and electrically connected to the circuit board.

In certain embodiments, the smart LED light may further include a lamp cover (not shown) and a base board 40. The lamp cover may be installed on the housing 20 and above the LED light-emitting module 51. The lamp cover may cover the housing and various components mounted inside the housing. The LED light-emitting module 51 may emit light to a surrounding area through the lamp cover. The base board 40 may be fixated inside the housing 20 and under the lamp cover. Various modules may be installed on the base board 40.

The smart LED light may further include a supplemental lighting module, a camera module, a sensor module, an audio acquisition module, an audio broadcast module, and/or a radio frequency (RF) antenna. The supplemental lighting module may be a supplemental infrared LED lighting module 52. Optionally, the infrared LED lighting module 52 may include two groups of infrared LED lamp beads. Each group may have 3 or 4 infrared LED lamp beads.

The camera module may be a camera 53. The camera 53 may have auto-focus capabilities. In one embodiment, the camera 53 may be movably mounted on the base board 40 inside the housing 20 and may adjust recording angles as needed. The camera may thus obtain desired video data. In certain embodiments, the audio acquisition module may be two microphones 56. The audio broadcast module may be a speaker 57.

The sensor module may be a passive infrared (PIR) human detection sensor 55 and/or a photo sensor 54. The human detection sensor 55 may be configured to detect whether a person appears within a detection range. The photo sensor 54 may be configured to detect an intensity of ambient light. According to the intensity of the ambient light, the photo sensor 54 may signal the supplemental lighting module to turn on, turn off or change the intensity of the supplemental light.

In an exemplary layout design, as shown in FIG. 1, the LED light-emitting module 51 may be located in the center of the lamp cover. The camera 53, the infrared LED lighting module 52 (a first group of infrared LED lamp beads), the microphones 56, the human detection sensor 55 and the infrared LED lighting module 52 (a second group of infrared LED lamp beads) may be sequentially distributed around the LED light-emitting module 51.

The lamp cover may include a first lens at a location corresponding to the location of LED light-emitting module 51, a second lens or a second group of lenses at location(s) corresponding to the locations of the supplemental infrared LED lighting module 52, and a third lens at a location corresponding to the location of human detection sensor 55. Further, the lamp cover may have openings at locations corresponding to the locations of camera 53, the photo sensor 54, the microphones 56 and the speaker 57, respectively.

In certain embodiments, when the smart LED lighting device is recording, at the same time period, only one of the LED light-emitting module 51 and the infrared LED lighting module 52 may be working. The infrared LED lighting module 52 is configured to provide supplemental lighting for the camera 53.

Heat generation of the smart LED light may affect the operations of camera 53, the microphones 56, the human detection sensor 55 and/or the photo sensor 54. In one embodiment, the base board 40 may be designed to include two parts. A first part base board 41 may be installed with the LED light-emitting module 51, the infrared LED lighting module 52 and the camera 53. Since the light-emitting module 51 and the infrared LED lighting module 52 may generate heat during lighting, the first part base board 41 may be an aluminum board to enhance heat dissipation.

A second part base board 42 may be installed with the microphones 56, the human detection sensor 55, the photo sensor 54 and/or the speaker 57. The two microphones 56 may be distributed on the two ends of the second part base board 42 to facilitate audio signal acquisition. In one embodiment, the distance between the two microphones may be about 8 cm to 10 cm to reduce noises in audio signals collected by the two microphones. Generally, the microphones 56, the human detection sensor 55, the photo sensor 54 and/or the speaker 57 do not generate much heat. In one embodiment, the second part base board 42 may be built with common material. In another embodiment, these modules may be directly mounted to the plastic base in the housing 20. That is, these modules may be installed inside the structure of the housing 20.

In certain embodiments, the smart LED lighting device may further include an RF antenna 58. The RF antenna 58 may be installed inside the housing 20 and electrically connected to the circuit board. Optionally, the RF antenna 58 may be a round shape or an arc shape that surrounds the base board 40. It is understood that the RF antenna may be other shapes and assembled at different locations to meet practical design or functional needs.

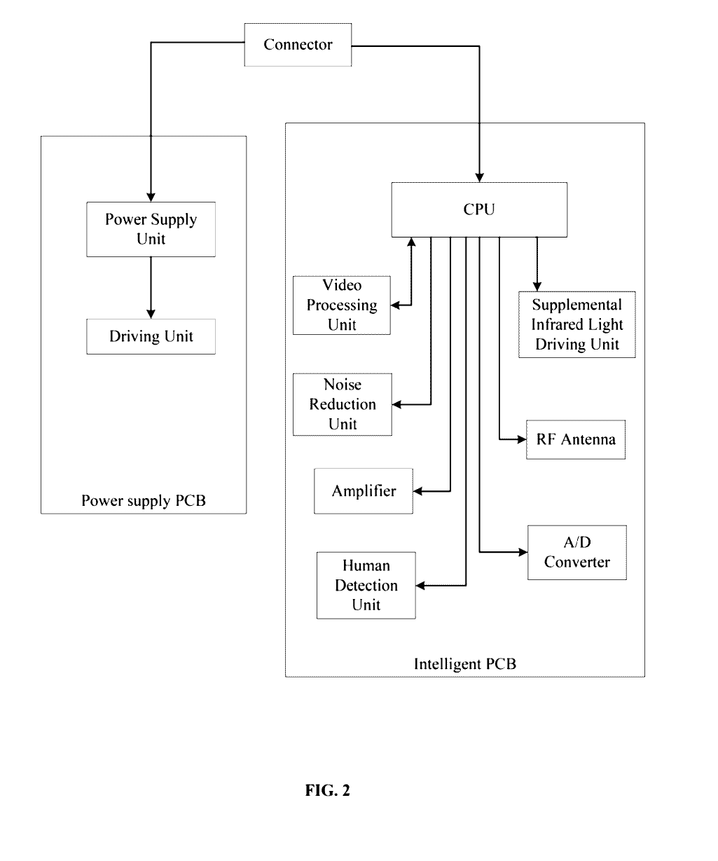

As shown in FIG. 2, an exemplary smart LED lighting device may have two circuit boards including an AC-DC (Alternating Current-Direct Current) power supply PCB (printed circuit board) and an intelligent PCB. The power supply PCB and the intelligent PCB may be electrically connected to each other through a connector. A structural spacer may be disposed between the two boards to control heat transfer. The connector may be configured to connect the two circuit boards so that the intelligent PCB may obtain primary DC voltage from the AC-DC power supply PCB.

The AC-DC power supply PCB may include a power supply unit and a driving unit. The power supply unit may electrically connect to the lamp cap and the driving unit.

The intelligent PCB may integrate a central processing unit (CPU) and various units connected to the CPU including a video processing unit, a noise reduction unit, an amplifier, an A/D converter, a human detection unit, an RF unit and/or a supplemental infrared lighting module driving unit.

The CPU may electrically connect to the connector. The CPU may be configured to receive and process various data transmitted from each unit and send instructions to corresponding units. The video processing unit may electrically connect to the camera 53. The video processing unit may process video and/or image data collected by the camera and send to the CPU. The noise reduction unit may electrically connect to the two microphones 56. The noise reduction unit may process audio signals collected by the microphones 56 to reduce or eliminate noise and send the audio signals to the CPU. The amplifier may electrically connect to the speaker 57. The amplifier may be configured to drive the speaker 57 to broadcast audio signals received from the CPU.

The A/D converter and the photo sensor 54 may be electrically connected. The A/D converter may be configured to convert light intensity signals collected by the photo sensor 54 to digital signals and send the digital signals to the CPU for analysis. The human detection unit and the human detection sensor 55 may be electrically connected. The human detection unit may process signals collected by the human detection sensor 55 and send to the CPU. The infrared lighting driving unit may be electrically connected to the infrared LED lighting module 52. The infrared lighting driving unit may be configured to drive the supplemental lighting module, and adjust an intensity of light emitted by the supplemental lighting module.

The RF unit may electrically connect to the RF antenna 58 so that the smart LED light may transmit data wirelessly. The transmitted data may include control signals to various modules, and/or collected videos and audio data. In certain embodiments, the RF unit may adopt 802.11a/b/g/n, 802.11ac or 2.4G WIFI technologies, or adopt 2.5G (GPRS), 3G (WCDMA) or 4G (LTE) mobile wireless communication technologies.

In another embodiment, all units may be integrated into one circuit board. The circuit board may include a CPU and various units connected to the CPU including a power supply unit, a driving unit, a video processing unit, a noise reduction unit, an amplifier, an A/D converter, a human detection unit, an RF unit and/or an infrared light driving unit.

The power supply unit may be configured to electrically connect to the lamp cap and provide regulated power supply to the CPU. The driving unit may electrically connect to the LED light-emitting module 51. The video processing unit and the camera 53 may be electrically connected. The noise reduction unit and the two microphones 56 may be electrically connected. The amplifier and the speaker 57 may be electrically connected. The A/D converter and the photo sensor 54 may be electrically connected. The human detection unit and the human detection sensor 55 may be electrically connected. The RF unit may be electrically connected to the RF antenna 58. The infrared light driving unit may be electrically connected to the infrared LED lighting module 52.

In one embodiment, the exemplary smart lighting device may have one circuit board integrated with all units. In another embodiment, the intelligent PCB may be added to an existing power supply circuit board, so that PCB layout of the existing circuit board is not affected. This approach may provide improvements and extend functionalities of traditional or existing lighting devices. Extensions may be provided to the modules on the base board 40 to meet practical needs. Further, the circuit boards may be changed or added according to practical needs.

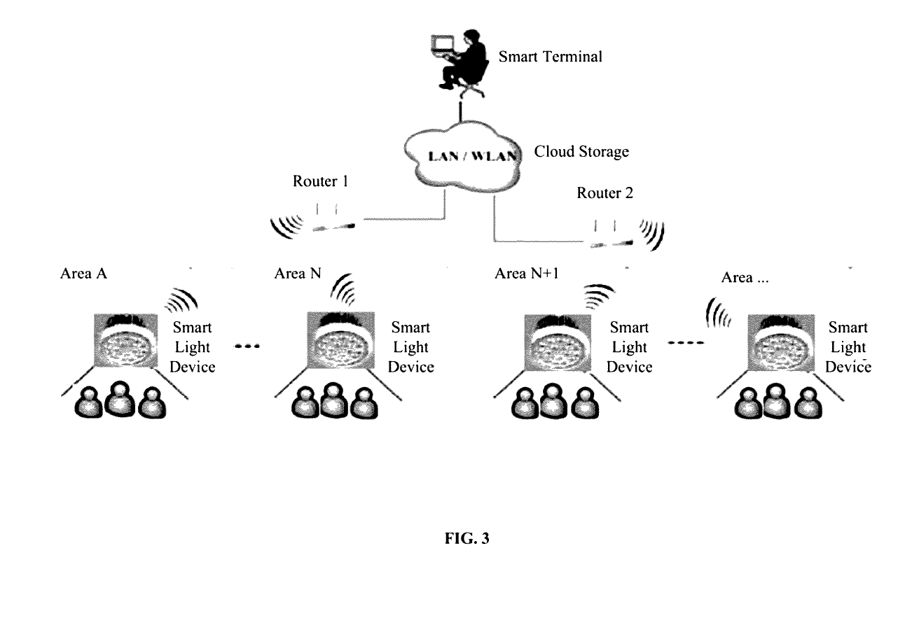

As shown in FIG. 3, an exemplary camera system consistent with the present disclosure may include a smart terminal, one or more routers, and one or more of the exemplary smart LED lighting devices. The smart LED lighting devices may be distributed and installed in a first group of areas within coverage range of a router 1 in a local area network (LAN). The smart LED lighting devices may provide lighting to a work/living space, and perform video surveillance to the first group of areas, such as area A, area N, etc. Existing LED assembly holes may be used to install these smart LED lighting devices. Further, a plurality of LED lighting devices may be distributed and installed in a second group of areas covered by a router 2 in a different local area network, such as area N+1. The amount of the smart LED lighting devices and area locations may be configured according to specific needs. The smart LED lights may connect to a router in the LAN through the RF antenna 58. In certain embodiments, the routers may be wireless routers.

The routers in different local networks may connect to the Internet. The smart LED lights may use the camera module to film and record, and transmit camera records to the Internet in real-time or upload the camera records to a cloud storage. The smart terminal such as a PC, a smart phone, a laptop computer, a tablet computer or a PDA (personal digital assistant), may connect to the Internet and view the camera data records recorded by the smart LED lighting devices through the Internet in real-time or view the camera data records uploaded in the cloud storage.

The smart LED lighting device consistent with the present disclosure may not only provide common LED lighting functions (such as providing lighting for a work space or a living space), but also perform video surveillance 24/7 under any ambient lighting conditions. When in operation, the smart LED lighting device may collect video and audio data in an acquisition area covered by the camera 53 and the microphones 56, generate camera data records, and transmit the camera records to the Internet in real-time. Users may use the smart terminal to browse the real-time camera records of any smart LED light by installing a corresponding APP (Application).

During day time or when there is plenty of light, the camera 53 may take videos or pictures using lighting provided by the smart LED lighting device or natural light. During night time or when there is insufficient lighting, the camera 53 may take videos or pictures using supplemental infrared light provided by supplemental infrared lighting module 52. The photo sensor 54 may detect light intensity variations and send feedback signals to the circuit board of the smart LED lighting device. During night time or when there is insufficient lighting, the smart LED light may turn off the LED light-emitting module 51 and turn on the infrared LED lighting module 52 to provide supplemental light for the camera 53. The infrared LED lighting module 52 does not emit visible light, therefore when working at night, the camera 53 would not affect users' normal rest, or the visible lighting provided by the smart LED light.

The photo sensor 54 may be configured to automatically detect ambient light intensity. When the ambient visible light becomes insufficient for camera 53 to operate properly, the smart LED lighting device may automatically turn on the infrared LED lighting module 52 to provide supplemental lighting. Further, intensity of the supplemental infrared lighting may be adjusted according to the ambient light intensity, which may save a lot of energy.

In certain embodiments, two smart lighting devices may be place at two locations that are very close to each other. If the photo sensor 54 in either of the two smart lighting devices detects insufficient ambient lighting, the two smart lighting devices may both turn on the infrared LED lighting modules 52 to provide more supplement lighting.

In certain embodiments, the smart light may also include a PIR human detection sensor 55. When sensing a person in a detection range, the smart lighting device may be triggered to save camera data records in the cloud storage. When no one is detected in the detection range, the camera data records may not be saved. This approach may save storage space and reduce demand for storage capacity on the cloud server. In other embodiments, the camera data records may be saved in the cloud storage in real-time. Further, when an intrusion is detected, the smart lighting device may trigger the speaker to sound the alarm and/or increase

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Comparing to the prior art, the disclosed smart lighting device may be configured to place the camera module on the side of the light-emitting module to prevent negative impacts on normal illumination angles of the smart light. Further, the smart lighting device may include a supplemental lighting module. During day time or when the surrounding area is well lit, the camera module may take videos or pictures using lighting provided by the smart lighting device or natural light. During nighttime or when there is insufficient lighting, the camera module may record videos or pictures with supplemental infrared light.

Meanwhile, various sensor modules may detect light intensities or human appearance to enable lighting adjustments or camera adjustments, which makes the smart lighting device more intelligent. The supplemental lighting module, the camera module and the sensor modules may be assembled inside the housing of the smart lighting device, so that the appearance and size of the lighting fixture may not be affected, which allows the smart light to be compact and have a desirable appearance.

The camera module is placed on the side of the LED light-emitting module to prevent generating dark areas. Such a layout may ensure proper lighting and image recording results. The smart lighting device may also integrate well into a home environment, providing lighting and video surveillance functions to users and creating a safe home or work environment.

The present disclosure also provides a camera system using the smart lighting devices. The smart LED lighting devices may locate in different areas, provide video surveillance functions in the covered areas as well as provide lighting functions. The smart lighting device may connect to the Internet through a router on a local network and transmit camera data records to the cloud storage. Users may connect to the Internet to view camera data records remotely using a smart terminal, which provides a convenient user experience and enhances the smart experience of the smart lighting device. It is understood that the smart lighting device may use other types of lighting fixtures besides LED light.

What is claimed is:

1. A smart lighting device, comprising:
a lamp cap configured to connect the smart lighting device with a power source;
a housing configured to be connected to the lamp cap;
a light-emitting module;
a camera module configured to capture image data in a surrounding area of the smart lighting device;
a supplemental lighting module configured to provide supplemental lighting for the camera module;
a sensor module; and
a circuit board configured to control the light-emitting module, the supplemental lighting module, the camera module and the sensor module;
wherein:
the light-emitting module, the supplemental lighting module, the camera module and the sensor module are mounted inside the housing and electrically connected to the circuit board;
the circuit board is mounted inside the housing and electrically connected to the lamp cap; and
the camera module, the supplemental lighting module and the sensor module are located around the light-emitting module.

2. The smart lighting device according to claim 1, further comprises a lamp cover configured to:
provide a first lens at a location corresponding to the light-emitting module, wherein the light-emitting module is located at the center of the lamp cover;
provide a second lens at a location corresponding to the supplemental lighting module; and
provide openings at locations corresponding to the camera module and the sensor module.

3. The smart lighting device according to claim 2, further comprises an audio acquisition module inside the housing and in the area surrounding the light-emitting module, the audio acquisition module being configured to:
electrically connect to the circuit board;
collect audio signals in the surrounding area of the smart light; and
send the audio signals to the circuit board;
wherein the lamp cover has a opening at a location corresponding to the audio acquisition module.

4. The smart lighting device according to claim 3, further comprises an audio broadcast module inside the housing and in the area surrounding the light-emitting module, the audio broadcast module being configured to:
electrically connect to the circuit board;
receive audio signals from the circuit board; and
broadcast the audio signals;
wherein the lamp cover has an opening at a location corresponding to the audio broadcast module.

5. The smart lighting device according to claim 2, wherein the sensor module further includes a human detection sensor configured to sense human appearance within a detection range.

6. The smart lighting device according to claim 5, wherein the sensor module further includes a photo sensor configured to:
detect ambient light intensity; and
signal the supplemental lighting module to turn on, turn off, or adjust an intensity of supplemental lighting according to the ambient light intensity.

7. The smart lighting device according to claim 1, further comprising an RF antenna installed inside the housing, the RF antenna being configured to:
electrically connect to the circuit board; and
transmit data between the circuit board and a router.

8. The smart lighting device according claim 1, wherein the circuit board further includes:
a power supply printed circuit board (PCB) configured to integrate a power supply unit and a driving unit; and
an intelligent PCB configured to integrate a central processing unit (CPU) and a plurality of units connected to the CPU including a video processing unit, an A/D converter and a supplemental infrared lighting module driving unit;
wherein:
the power supply PCB and the intelligent PCB are electrically connected through a connector;
the power supply unit is electrically connected to the lamp cap and the driving unit;
the driving unit is electrically connected to the light-emitting module to drive the light-emitting module;
the CPU is configured to electrically connect to the connector, receive and process data transmitted from the plurality of units, and send instructions to corresponding units;
the video processing unit is configured to electrically connect to the camera module, process videos or images collected by the camera module, and send the videos or images to the CPU;
the A/D converter is configured to electrically connect to the sensor module, convert signals collected by the sensor module to digital signals, and send the digital signals to the CPU; and
the infrared supplemental lighting driving unit is configured to electrically connect the supplemental lighting module, drive the supplemental lighting module, and adjust an intensity of a light emitted by the supplemental lighting module.

9. The smart lighting device according to claim 8, wherein:
the smart lighting device further comprises two microphones and a speaker;
the plurality of units further include a noise reduction unit and an amplifier;
the noise reduction unit is configured to electrically connect to the two microphones, process audio signals collected by the two microphones to reduce or eliminate noise, and send the processed audio signals to the CPU; and
the amplifier is configured to electrically connect to the speaker, and drive the speaker to broadcast audio signals received from the CPU.

10. The smart lighting device according to claim 1, wherein
a base board is placed inside the housing; and
the base board is configured to carry the light-emitting module, the supplemental lighting module, the camera module, and the sensor module.

11. The smart lighting device according to claim 10, wherein:
the base board includes a first part base board and a second part base board;
the light-emitting module, the supplemental lighting module, and the camera module are installed on the first part base board;
the sensor module is installed on the second part base board; and
the first part base board is an aluminum base board.

12. The smart lighting device according to claim 1, wherein:
the light-emitting module includes a single lamp bead or a collection of a plurality of lamp beads.

13. The smart lighting device according to claim 12, wherein:
the lamp bead is an LED light.

14. The smart lighting device according to claim 1, wherein:
the supplemental lighting module includes at least two groups of infrared lamp beads; and
the infrared lamp beads are located on both sides of the camera module.

15. The smart lighting device according to claim 14, wherein:
the infrared lamp beads are infrared LED lights.

16. The smart lighting device according to claim 1, wherein the camera module is a camera configured to have auto-focus capabilities and can adjust recording angles.

17. A camera system, comprising:
one or more routers; and
one or more smart lighting devices configured to include a lamp cap, a housing, a circuit board, a light-emitting module, a supplemental lighting module, a camera module and a sensor module;
wherein:
each smart light is connected to a router in a local network;
the one or more routers are connected to the Internet; and
the smart lighting device is configured to record camera data records using the camera module, and send the camera data records to the Internet through the routers in real-time or upload the camera data records to a cloud storage.

18. A camera system, comprising:
a smart terminal;
one or more routers; and
one or more smart lighting devices configured to include a lamp cap, a housing, a circuit board, a light-emitting module, a supplemental lighting module, a camera module and a sensor module;
wherein:
each smart light is connected to a router in a local network;
the one or more routers are connected to the Internet;
the smart light is configured to record camera data records using the camera module, and send the camera data records to the Internet through the routers in real-time or upload the camera data records to a cloud storage; and
the smart terminal is configured to access the camera data records in real-time through the Internet or access the uploaded camera records in the cloud storage.

19. The camera system according to claim 18, wherein:
the routers are wireless routers;
the smart lighting devices include a radio frequency module; and
the smart lighting devices are wirelessly connected to the routers.

20. The camera system according to claim 18, wherein:
the smart terminal is a personal computer, a smart phone, a laptop computer, a tablet computer or a personal digital assistant (PDA).
